(19) United States
(12) Patent Application Publication
(10) Pub. No.: US 2023/0365865 A1
(43) Pub. Date: Nov. 16, 2023

(54) ATMOSPHERIC WATER HARVESTING SYSTEM

(71) Applicant: Board of Regents, The University of Texas System, Austin, TX (US)

(72) Inventors: Guihua Yu, Austin, TX (US); Fei Zhao, Austin, TX (US); Xingyi Zhou, Austin, TX (US)

(21) Appl. No.: 18/029,293

(22) PCT Filed: Oct. 4, 2021
(86) PCT No.: PCT/US21/53341

§ 371 Date: Mar. 29, 2023

Related U.S. Application Data
(60) Provisional application No. 63/086,803, filed on Oct. 2, 2020.

(51) Int. Cl. C09K 17/22; B01J 20/26; C08F 271/02; A01G 24/35

(52) U.S. Cl. CPC C09K 17/22; B01J 20/264; C08F 271/02; A01G 24/35

(57) ABSTRACT

Disclosed herein are improved soils for use in agriculture and other fields. The improved soils include atmospheric water harvesting networks which more efficiently hydrate the soil, reducing the need for external water inputs in germination and growth stages.

### CROSS-REFERENCE TO RELATED APPLICATION

This application claims the benefit of U.S. Provisional Application 63/086,803, filed on Oct. 2, 2020, the contents of which are hereby incorporated in their entirety.

### FIELD OF THE INVENTION

The invention is directed to materials and methods for improving moisture absorption and retention in soils and other growing media. The materials and methods disclosed herein can improve agricultural yields, reduce agricultural water consumption, and prevent desertification.

### BACKGROUND

Water is the basic environmental factor for agricultural food production. However, drylands account for over 40% of the earth's land surface, including 45% of the global agricultural land. Climate change and anthropogenic contamination exacerbate the desertification, exposing the agricultural production to the threat of water deficit. Liberating the crop farming from the complex water supply chain will have a significant impact on the reduction of costs, as well as provide marked ecological advantages, especially in drought regions. Such urgent need motivates the exploration of a new water resource—atmospheric water, which can be utilized regardless of the geographical and hydrologic conditions. The recent achievement of atmospheric water harvesters (AWHs) enables a passive method to obtain water from the air. Such technology holds the promise for the energetic sustainability of agriculture by developing solar-powered and distributable systems that can provide water without the need for centralized water and power supply (e.g., external water inputs). Moreover, the sandy soils in drylands exhibit poor water holding capacity and thus lead to land degradation, which suppresses the critical phases in plant growth, including seed germination and establishment. Water management in the soil is also significant to combat the water loss caused by evaporation and/or drainage.

There remains a need for materials and methods for reducing external water inputs for agriculture. There remains a need for improved soils, sands, and other growing media that require less external water. There remains a need for improved soils, sands, and other growing media that more efficiently make use of atmospheric moisture. There remains a need for improved soils, sands, and other growing media that are more resistant to erosion, desertification, and other processes which reduce agricultural efficiency.

### SUMMARY

Disclosed herein are compositions and methods which address one or more of the foregoing needs. In particular are disclosed modified soils capable of absorbing atmospheric moisture, including in low humidity conditions. Also disclosed are modified soils capable of absorbing and release moisture without electrical energy inputs. The modified soils include water harvesting polymer networks admixed with one or more soils, sands, earths, and other growing media.

The details of one or more embodiments are set forth in the descriptions below. Other features, objects, and advantages will be apparent from the description and from the claims.

### BRIEF DESCRIPTION OF THE FIGURES

FIG. 1 depicts (a) Schematic of the atmospheric water irrigation based on super moisture absorbent gels (SMAG) for sustainable agriculture. (b) The water capturing and releasing behavior of the SMAG. The inset images show the SMAG in dried and hydrated states. Scale bars: 5 cm. (c) Water uptake of the SMAG-soil and the sandy soil at RH=90% and 20° C. (d) Water holding capacities of the SMAG-soil and the sandy soil at RH=40% and 40° C.

FIG. 2 depicts (a) Schematic of atmospheric water irrigation system based on the SMAG-soil for plant growth. (b) The moisture capturing and releasing cycles of the SMAG-soil. (c) Photograph of the device with growing radish plants. (d) The RH outside (Environment) and inside (SMAG-soil) the planting chamber starting from 10 AM (day 1) to 10 AM (day 2). (e) The RH outside (Environment) and inside (SMAG-soil) at 2 PM in 20 days. (f) The water content of the SMAG-soil, the solar reflux and surrounding temperature at 2 PM in 20 days. (g) The germination rate of plants in the sandy soil and the SMAG-soil with irrigation of different times. (h) The plant height with the SMAG-soil and the sandy soil without irrigation in 14 days. The inset images show the plants in the SMAG-soil and the sandy soil, respectively. Scale bar: 2 cm. (i) The survival rate of radish plants in the SMAG-soil and the sandy soil without irrigation in 14 days.

FIG. 3 includes a depiction of (a) Water uptake of the SMAG. (b-c) Photographs of (b) dehydrated and (b) fully swollen SMAG samples. The SMAG is able to capture water almost 5 times of its own weight from the air in 12h and store the obtained water until the whole SMAG is heated for water releasing.

FIG. 4 includes a depiction of SEM images of (a) particles of the sandy soil and (b) the surface of the particle in comparison with (c) the SMAG particle in the SMAG-soil and (d) the corresponding surface. The sandy soil presents rough surfaces while the SMAG particle shows a typical smooth surface. The SMAG-soil is composed of uniformly mixed SMAG particles in the sandy soil.

FIG. 5 includes a depiction of (a) Water capturing and (b) releasing behavior of the SMAG-sand and the sand. Water content, also known as natural water content or natural moisture content, is the ratio of the weight of water to the weight of the solids in a given mass of soil. As an extended example, SMAG can help to increase the water content in sand as well. The SMAG-sand presents improved water harvesting performance and water holding capability, indicating that SMAG provides a new platform for water-related soil improvement such as prevention and control of desertification.

FIG. 6 includes a depiction of the plant growing device demonstrating the atmospheric water harvesting and environmental RH management in the evening and at noon of hot summer days (July/August) in Texas. Upon a cool and moist environment, the SMAG-soil is exposed to the open air to capture moisture from the atmosphere. During the hot daytime with relative low RH condition, the SMAG can release water to the soil directly and keep evaporating contained water to the environment to stabilize the RH in the planting chamber.

FIG. 7 includes a depiction of the RH of the environment outside (i.e., Environment) and inside (i.e., Sandy soil) of the sandy soil based planting chamber as a control sample to the SMAG-soil. The RH near the sandy soil is almost the same with the environmental RH.

FIG. 8 includes a depiction of the RH of the environment outside (i.e., Environment, squares) and inside the sand (triangles) and SMAG-sand (circles) chambers. The results clearly show that SMAG can be used on drylands with different drought levels.

FIG. 9 depicts the bud/root length ratio of the plants with the SMAG-soil and the sandy soil over time. Apart from the germination rate and the survival rate, we also observed the bud/root length ratio of plants in the SMAG-soil and the sandy soil without water irrigation. The high ratio in the SMAG-soil case compared with the sandy soil one indicates better water supply to the plants.

FIG. 10 depicts the survival rate of plants in the sand and SMAG-sand when irrigating after several days. The survival rate of plants in the sand decreased over time due to the gradually water loss and resulted low RH near the plants. While the SMAG-sand enables stable and high RH near the plants, leading to the survival of all plants.

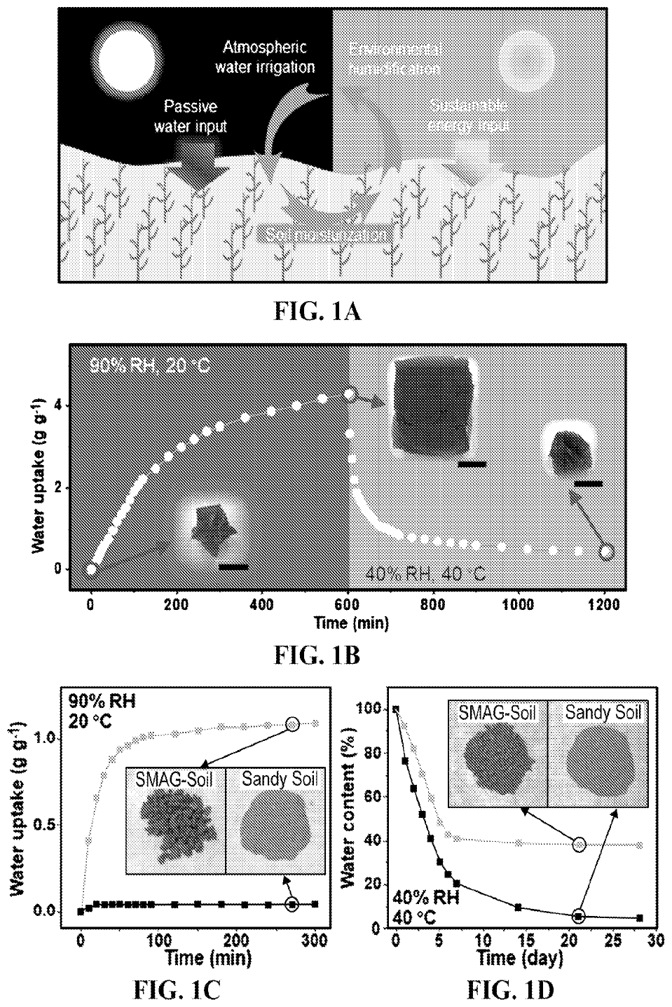

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

Water Harvesting Polymer Networks

The moisture harvesting networks include interpenetrating networks of hygroscopic polymers and thermoresponsive water storage polymers. Interpenetrating networks include those formed by forming one of the polymers (by polymerization) in the presence of the already-formed other polymer. The hygroscopic system absorbs moisture from the air, which is stored and selectively released by the thermoresponsive water storage system. As used herein, a moisture harvesting network can be designated a “super moisture absorbent gels,” or “SMAG.” The storage modulus (G′) and loss modulus (G″) values can be used to determine if a network includes interpenetrating polymers. For instance, the interpenetrating networks disclosed herein will have lower G′, lower G″, or both lower G′ and G″ values than either the pure hygroscopic polymer, pure thermoresponsive water storage polymer, or simple mixtures of hygroscopic polymer and thermoresponsive water storage polymer. A simple mixture refers to the combination of two separately formed polymers. In certain embodiments, the storage modulus of the interpenetrating network will be less than the storage modulus of a simple mixture of the same polymers, in the same amounts. For instance, the storage modulus of the interpenetrating network can be 10% less, 25% less, 50% less, or 75% less than the storage modulus of the equivalent simple mixture of the same polymers. In certain embodiments, the loss modulus of the interpenetrating network will be less than the loss modulus of a simple mixture of the same polymers, in the same amounts. For instance, the loss modulus of the interpenetrating network can be 10% less, 25% less, 50% less, or 75% less than the loss modulus of the equivalent simple mixture of the same polymers.

Hygroscopic polymer systems include those capable of extracting water from the atmosphere. Hygroscopic polymers include those that can absorb at least 50%, at least 100%, at least 150%, at least 200%, at least 250%, at least 300%, at least 350%, at least 400%, at least 450%, at least 500%, at least 550%, at least 600%, at least 650%, at least 700%, at least 750%, at least 800%, at least 850%, at least 900%, at least 950%, or at least 1000% by weight of water, relative to the dry weight of the polymer. Hygroscopic polymers include those having a mass average molar mass of less than 500,000, less than 450,000, less than 400,000, less than 350,000, less than 300,000, less than 250,000, less than 200,000, less than 175,000, less than 150,000, less than 125,000, less than 100,000, less than 75,000, or less than 50,000. Exemplary hygroscopic polymers include polyesters, polycarbonates, poly(meth)acrylates, polyacrylonitriles (e.g., ABS resins), poly(meth)acylamides, polysaccharides, polyheterocycles, polysiloxanes, and copolymers thereof.

In some instances, the hygroscopic polymer can include one or more ionically charged polymers, for instance, polyacrylic acids, functionalized poly(meth)acrylates and poly(meth)acrylamides such as aminoalkyl (meth)acrylates and (meth)acrylamides. Exemplary conductive polymers include polypyrroles, polyanilines, polycarbazoles, polyindoles, polyazepines and copolymers thereof. Copolymers include polymers derived from two or more monomers including pyrroles, anilines, carbazoles, indoles, azepines, acrylic acids, functionalized (meth)acrylates and (meth)acrylamides. The copolymer can be a random copolymer, such as formed when two or more monomers are polymerized together. The copolymer can be a block copolymer, such as when individual monomers are polymerized and subsequently joined together.

In some instances, the conductive polymer can include one or more doped conductive polymers. Doped polymers include polymers that have been oxidized (p-doping) or reduced (n-doping). In some instances, conductive polymers containing basic atoms can be doped under non-redox conditions, for instance by reaction with an acid. Exemplary acids include mineral acids such as hydrochloric acid, hydrobromic acid, hydroiodic acid, sulfuric acid, nitric acid, phosphoric acid, perchloric acid, and tetrafluoroboric acid. Other acids include organic acids such as sulfonic acids (e.g., toluenesulfonic acid, camphorsulfonic acid, benzenesulfonic acid, methanesulfonic acid, and trifluorosulfonic acid), as well as carboxylic acids (e.g., trifluoroacetic acid and trichloroacetic acid). The use of such compounds leads to doped polymers including one or more anions such as chloride, bromide, iodide, sulfate, phosphate, nitrate, perchlorate, tetrafluoroborate, sulfonate, acetates, and mixtures thereof.

Doped polymers may be characterized by the number of holes per monomer. In some embodiments the doping level is at least 0.010, 0.025, 0.050, 0.075, 0.100, 0.125, 0.150, 0.175, 0.200, 0.225, 0.250, 0.275, 0.300, 0.325, 0.350, 0.375, 0.400, 0.425, 0.450, 0.475, 0.500, 0.525, 0.550, 0.575, 0.600, 0.625, 0.650, 0.675, 0.700, 0.725, 0.750, 0.775, 0.800, 0.825, 0.850, 0.875, 0.900, 0.925, 0.950, or 0.975 holes per monomer. In some embodiments, the doping level can be from 0.010-1.0; from 0.10-1.0; from 0.20-1.0; from 0.30-1.0; from 0.40-1.0; from 0.50-1.0; from 0.60-1.0; from 0.70-1.0; from 0.80-1.0; from 0.90-1.0; from 0.10-0.75; from 0.20-0.75; from 0.30-0.75; from 0.40-0.75; from 0.50-0.75; from 0.10-0.50; from 0.20-0.50; from 0.30-0.50; or from 0.40-0.50.

In certain embodiments, the hygroscopic polymer can be a poly(pyrrole), poly(aniline), a mixture thereof, or a copolymer thereof. Exemplary dopants include chloride, bromide, phosphate and tetrafluoroborate. In some embodiments, the hygroscopic polymer can have a mass average molar mass of less than 100,000, less than 90,000, less than 80,000, less than 70,000, less than 60,000, or less than 50,000. The hygroscopic polymer can have a mass average molar mass from 35,000-100,000, from 50,000-100,000, from 50,000-90,000, from 50,000-80,000, from 50,000-70,000, from 50,000-60,000, from 35,000-50,000, or from 35,000-75,000.

Thermoresponsive polymers include those which selectively retain or release water based on temperature. Such systems exhibit a volume phase transition at a certain temperature, resulting in a sudden change of the solvation state. Polymers that become less soluble (or insoluble) in water as temperature increases are characterized by a Lower Critical Solution Temperature (LCST). Thermoresponsive polymers that can be used in water harvesting systems can have an LCST from about 10-80° C., 20-70° C., 25-70° C., 30-70° C., 30-65° C., or 30-60° C.

In some instances, the thermoresponsive water storage polymer can include one or more poly(N-alkylacrylamides), poly(N,N dialkylacrylamides), poly(acrylic acids), poly(vinyl ethers), or poly(vinylcaprolactams). Thermoresponsive water storage polymers can be derived from one or more monomers including N-alkylacrylamides, N,N-dialkylacrylamides, vinyl ethers, acrylic acid, and vinylcaprolactam. The thermoresponsive water storage polymer can further include monomers such as acrylic acid and/or acrylamide. The N-alkylacrylamide can be an N—C₁-C₄alkylacrylamide, the N,N-dialkylacrylamide can be an N,N-di(C₁-C₄)alkylacrylamide. The alkyl groups in in the N,N-dialkylacrylamides can be the same, or can be different. When the thermoresponsive polymer is a copolymer, it can be a random copolymer or block copolymer. Exemplary thermoresponsive storage polymers can be derived from N-alkylacrylamide and/or N,N-dialkylacrylamide monomers, and may further be derived from acrylic acid, including salts thereof, and/or acrylamide. The thermoresponsive storage polymer can be derived from one or more monomers such as methylacrylamide, ethylacrylamide, n-propylacrylamide, iso-propylacrylamide, n-butylacrylamide, iso-butylacrylamide, sec-butylacrylamide, tert-butylacrylamide, dimethylacrylamide, diethylacrylamide, di-n-propylacrylamide, di-iso-propylacrylamide, N-methyl-N-ethylacrylamide, N-methyl-N-n-propylacrylamide, N-ethyl-N-n-propylacrylamide, N-methyl-N-iso-propylacrylamide, and N-ethyl-N-iso-propylacrylamide. In some instance, the thermoresponsive polymer is derived from monomers including N-isopropylacrylamide or N,N-diethylacrylamide, and can further include monomers of acrylamide and/or acrylic acid. In certain embodiments, the thermoresponsive polymer can include block copolymers of polyethylene oxide and polypropylene oxide.

The thermoresponsive water storage polymer can be a crosslinked polymer. Crosslinked polymers can be obtained by polymerizing the monomers in the presence of one or more crosslinking monomers. Crosslinked polymers can be derived from one or more monomers having two or more vinyl groups. In some instance, the crosslinking monomer will contain two, three, four, five or six vinyl groups. Exemplary crosslinking monomers include (C₁-C₁₀alkylene) bisacrylamide, such as N,N-methylenebisacrylamide, N,N-ethylenebisacrylamide, N,N-propylenebisacrylamide, and functionalized acrylamides including mono and di-(C₃-C₁₀alkenyl) acrylamide such as N-allylacrylamide or N,N-diallylacrylamide. The molar ratio of crosslinking monomers to other monomers can be from 1:10,000 to 1:100, from 1:5,000 to 1:100, from 1:2,500 to 1:100, from 1:2,000 to 1:100, from 1:1,500 to 1:100, from 1:1,000 to 1:100, from 1:750 to 1:100, from 1:500 to 1:100, from 1:250 to 1:100, from 1:5,000 to 1:500, from 1:5,000 to 1:1,000, from 1:5,000 to 1:2,500, from 1:5,000 to 1:3,000, from 1:4,000 to 1,1000, from 1:4,000 to 1:2000, from 1:7,500 to 1:2,500, or from 1:10,000 to 1:5,000.

In certain embodiments, the water harvesting networks do not include a cellulose polymer. As used herein, a cellulose polymer refers to any polysaccharide comprising repeating 1,4-β-glucose units. Cellulose polymers, as used herein, include modified cellulose, for instance modified with carboxy, alkyl, or hydroxyalkyl groups.

The water harvesting networks can be characterized according to the (dry) weight ratio of the hygroscopic polymer to thermoresponsive polymer. For instance, the ratio of hygroscopic polymer to thermoresponsive water storage polymer can be from about 1:0.05-1:1, 1:0.1-1:1, 1:0.25-1:1, 1:0.50-1:1, 1:0.75-1:1, 1:0.05-1:0.75, 1:0.1-1:0.75, 1:0.25-1:0.75, 1:0.50-1:0.75, 1:0.05-1:0.50, 1:0.10-1:0.50, 1:0.25-1:0.50, or 1:0.25-1:0.75. In some instances, the weight fraction of the hygroscopic polymer can be at least 50%, at least 60%, at least 70%, at least 80%, at least 85%, at least 90%, or at least 95%, relative to the total weight of the polymer network.

The interpenetrating water harvesting networks can be prepared by polymerizing one component of the network in the presence of the already formed polymer of the other component. For instance, monomer precursors of the thermoresponsive water storage polymer can be combined with a hygroscopic polymer, and then subjected the conditions suitable to form the thermoresponsive water storage polymer. In other embodiments, monomer precursors of the hygroscopic polymer can be combined with a thermoresponsive water storage polymer, and then subjected the conditions suitable to form the hygroscopic polymer.

Prior to combination with soil, the water harvesting network can be particulate in nature. The water harvesting network can have an average particle size from 0.1 μm to 500 μm, from 0.1 μm to 250 μm, from 0.1 μm to 100 μm, from 0.1 μm to 50 μm, from 0.1 μm to 25 μm, from 0.1 μm to 10 μm, from 0.1 μm to 5 μm, from 0.1 μm to 1 μm, from 1 μm to 500 μm, from 10 μm to 500 μm, from 25 μm to 500 μm, from 50 μm to 500 μm, from 100 μm to 500 μm, from 250 μm to 500 μm, from 1 μm to 50 μm, from 5 μm to 25 μm, from 10 μm to 100 μm, from 25 μm to 150 μm, from 50 μm to 250 μm, or from 100 μm to 300 μm.

Soils

Soil, broadly defined, consists of the top-most layer of earth where plants, fungi, and other organisms grow. Soil particles are natural entities of soil of various sizes including sand, silt and clay, and may exist as separate tiny units or clumped together in crumbs, Soil contains soil particles of different sizes. The term “particle size” as used herein refers to the average particle size of a particle. The spaces between the soil particles and/or crumbs are pores. Ideally, pore spaces in soil are large enough to leave room for air and allow excess water to drain away, and small enough to hold sufficient water for growth of plants and other organisms.

Soil particles are generally defined by their sizes. For example, sand particles can have a particle size of 0.05-2.00 mm; silt particles can have a particle size of 0.002-0.05 mm; and clay particles can have a particle size less than 0.002 mm.

A soil sample may be characterized by weight percentages of soil particles having different sizes in the soil sample. The term “soil texture” as used herein refers to soil particle size distribution of a soil sample, i.e., weight percentages of soil particles of different sizes in a soil sample. The physical and chemical properties of a soil sample may be affected by a change in its soil texture. Soil texture is an important characteristic of a soil sample that may influence water absorption, water retention, tillage operation, aeration status and fertility of the soil sample. In general, a soil sample having fine particles and small pore spaces retain more water than a soil sample having larger particles and large pore spaces. The U.S. Department of Agriculture defines 12 soil texture groups (i.e., sand, loamy sand, sandy loam, loam, silt loam, silt, sandy clay loam, clay loam, silty clay loam, sandy clay, silty clay and clay) for a soil sample based on weight percentages of sand, silt and clay particles in the soil sample. The soil can also include materials such as mulch, topsoil, hydroponics, gravel, and compost. Root holding media, such as wood fibers, peat, forest bark, straw, loam, clay aggregate (e.g., light expanded clay aggregate or LECA) and particulate plastics material can also be used.

SMAG-Modified Soils

The water harvesting network can be combined with soil in a variety of ratios, depending on the specific climate to modified soils are deployed in, as well as the specific crop being grown. Increasing the amount of the water harvesting network enhances water uptake from the atmosphere, while increased amounts of soil provide better water and nutrient transport. For example, modified soils can include water harvesting networks in an amount from 1-50% by weight, 1-25% by weight, 1-10% by weight, 1-5% by weight, 5-50% by weight, 5-25% by weight, 5-10% by weight, 10-50% by weight, 20-50% by weight, from 40-75% by weight, from 25-75% by weight, from 50-75% by weight, from 75-95% by weight, 5-20% by weight, 5-15% by weight, 20-30% by weight, or 15-35% by weight, relative to the total weight of the modified soil composition. As used herein, the total weight includes any additional components as described herein.

The structure of the soil assembly is one of the most important factors determining soil health and crop productivity. The soil assembly structure greatly influences the drainage and water holding capacity of the soil as well as other crucial factors including the aeration available in the soil. As used herein, a “soil assembly structure” refers to composite of both soil and water harvesting network. A healthy soil, which is a good aggregate or friable soil with good moisture-holding capacity and plenty of drainages to allow roots to thrive The modified soils/soil assembly structure can be produced in particulate form using dry grinding, wet grinding, wet-dry cycling, freeze-thaw cycling, etc. The soil assembly structure can further be modified using polyvalent cations like Ca²⁺, Mg²⁺ and Al³⁺ can bind clay particles together. In some embodiments, soil particles can be cemented together using humus, organic glues created by fungi and bacteria decomposing organic matter and/or by polymers excreted from roots. The soil assembly structure can have an average particle size from 1 μm to 1 cm, for example from 1 μm to 1 mm, from 1 μm to 500 μm, from 1 μm to 250 μm, from 1 μm to 100 μm, from 1 μm to 50 μm, from 50 μm to 1 mm, from 100 μm to 1 mm, from 250 μm to 1 mm, from 500 μm to 1 mm, from 750 μm to 1 mm, from 50 μm to 500 μm, from 50 μm to 250 μm, from 50 μm to 100 μm, from 250 μm to 500 μm, from 250 μm to 750 μm, from 1 mm to 1 cm, from 10 mm to 1 cm, from 100 mm to 1 cm, from 250 mm to 1 cm, from 500 mm to 1 cm, from 10 mm to 500 mm, from 10 mm to 250 mm, from 10 mm to 100 mm, from 50 mm to 500 mm, or from 250 mm to 750 mm.

The modified soils can include other additives used in agriculture, for instance nutrients supporting plant growth (e.g., a fertilizer), organic acids, minerals, symbiotic fungi, and polysaccharides.

Suitable nutrients include nitrogen (N), phosphorus (P), potassium (K), calcium (Ca), magnesium (Mg), and sulfur (S), copper (Cu), iron (Fe), manganese (Mn), zinc (Zn), boron (B), molybdenum (Mo), and selenium (Se). The combination of nitrogen, phosphorous and potassium are especially useful, which may be present in an amount from 0.1-20% by weight, from 0.5-20% by weight, from 1-20% by weight, from 5-20% by weight, from 10-20% by weight, from 0.5-5% by weight, from 1-10% by weight, or from 5-15% by weight.

Suitable organic acids include humic acid, alginic acid, nucleic acids, amino acids (for example agricultural grade amino acid mixtures), and fatty acids. Exemplary fatty acids hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, stearic acid (octadecanoic acid), nonadecanoic acid, eicosanoic acid, myristoleic acid, palmitoleic acid, sapienic acid, oleic acid, linoleic acid, α-linolenic acid, α-linolenic acid, arachidonic acid, and eicosapentaenoic acid. Organic acids may be present in an amount from 1-20% by weight, from 1-10% by weight, from 5-15% by weight, from 0.5-5% by weight, or from 10-20% by weight.

Suitable minerals include silicates, carbonates, sulfates, oxides, phosphates, oxalates, mellitates, citrates, acetates, and formats, for example manganese sulfate, zinc sulfate, copper sulfate, ferrous sulfate, ammonium molybdate, and borax (i.e., sodium borate). Minerals include phosphate rocks, potassium rocks, shell rocks, zeolites, bone meal such as fish bone meal, lime, and glacial rock dust. Minerals can be included in amount from 0.1-10% by weight, from 1-10% by weight, from 5-10% by weight, or from 0.1-5% weight.

Suitable polysaccharides include starch, glycogen, cellulose, and chitin, which may be present in an amount from 0.1-10% by weight, from 1-10% by weight, from 5-10% by weight, or from 0.1-5% weight. When used as an additive, the polysaccharide is distinct from, and not part of the interpenetrating network that forms the SMAG.

Symbiotic fungi include Mycorrhizae and Rhizobia.

The modified soils may be formulated at certain pH depending on the intended crop. For example, the soil can have a pH from 5.5-7.5, from 5.5-7.0, from 5.5-6.99, from 6-8, from 6-6.99, from 7-8, from 7.01-8, or from 7.5-8.

The modified soils may have improved water retention compared with a control composition, e.g., the same soil composition but without the water harvesting polymer network. The water retention of the soil composition may be as least 25%, 50%, 75%, 100%, 200%, 300%, 400%, or 500% greater higher than that of the control composition.

The SMAG soil may be prepared by mixing a water harvesting network and soil together. In some instances the water harvesting network and soil can be combined in a mechanical mixture, dispersed with water, and mixed thoroughly. The water may be added prior to mixing, or may be added dropwise while mixing. The water:dry component mixture may have a weight ratio from 25:1 to 1:25, from 10:1 to 1:10, from 5:1 to 1:5, from 2.5:1 to 1:2.5, from 2.5:1 to 1:1, from 5:1 to 1:1, from 10:1 to 1:1 from 10:1 to 5:1, from 1:1 to 2.5:1, from 1:1 to 5:1, from 1:1 to 10:1, or from 1:5 to 1:10. The particle size may be controlled through selection of mechanical shear force and duration of grinding. The wet material may be dried and then ground or ball milled to give the modified soil composition. Suitable drying temperatures include greater than 30° C., greater than 40° C., greater than 50° C., greater than 6° C., greater than 70° C., greater than 80° C., greater than 90° C., and greater than 100° C. Particle size may be further controlled using sieve techniques. Modified soil compositions may further be subjected to freeze/thaw cycling to optimize soil assembly structure.

The modified soils may be added to agricultural fields at varying rates, depending on the quality of the existing soil in the agricultural field, the local weather patterns, and the intended crop. For example, the modified soil composition can be added to a field at a rate of 0.1-1,000 lb/ft², 1-100 lb/ft², 5-100 lb/ft², 5-50 lb/ft², 5-25 lb/ft², 10-100 lb/ft², 10-50 lb/ft², 10-25 lb/ft², 25-100 lb/ft², 50-100 lb/ft², or 100-500 lb/ft². In some instances, the modified soil may simply be laid on top of the field, while in other embodiments the pre-existing soil may be tilled with the modified soils.

Disclosed herein are methods of germinating seeds and growing plants using less external water inputs than would be required with conventional soils. In an embodiment, the seed is contacted or buried in the modified soil (depending on the individual need of the plant species). Seeds disposed in the modified soils germinate more rapidly, and grow more readily, as the modified soils extract moisture from the atmosphere much more readily than conventional soils.

Suitable seeds that may be germinated in the modified soils include: specialty crops, field crops, trees. Specialty crops include vegetables, fruits and seeds. In some instances the crop is Açai palm, Aardaker, Abacá, Abaca, Abacas, Abiu, Absinthe wormwood, Absinthium, Abyssinian Banana, Abyssinian mustard, Acai berry, Acai palm, Acai palm tree, Acerola, Achacha, Achachairú, Ackee, Adlai, Adlay, Aduki bean, Adzuki bean, African daisy, African ebony, African eggplant, African homed cucumber, African homed melon, African mangosteen, African millet, African moringa, African oil palm, African pear, African pepper, African rice, African spinach, African spinach, African star apple, African tamarind, African teak, Agati, Air potato, Aji, Ajowan, Ajowan caraway, Ajwain, Akee, Akee apple, Alexanders, Alfalfa, Alisanders, Alligator apple, Alligator pear, Alligator pepper, Allspice, Almond, Aloe vera, Alpine currant, Amaranth, Ambarella, American Cranberry, American gooseberry, American groundnut, American oil palm, American persimmon, Amla, Ana tree, Andean lupin, Angled luffa, Anis, Anise, Aniseed, Annual Bunch Grass, Annual yellow lupin, Apple, Apple gourd, Apple guava, Apple of Cain, Apple pear, Apple star, Apple-ring acacia, Apricot, Arabica coffee, Arazá, Arctic kiwi, Areca nut, Areca nut palm, Areca palm, Arikara squash, Armenian cucumber, Arracacha, Arrowleaf elephant ear, Arrowleaf elephant's ear, Arrowroot, Artichoke, Artichoke thistle, Arugula, Ash gourd, Asian basil, Asian coinleaf, Asian palmyra palm, Asian pear, Asian persimmon, Asian pigeonwings, Asian rice, Asiatic pennywort, Asparagus, Asparagus bean, Asparagus bean, Asparagus lettuce, Aster, Atemoya, Australian desert raisin, Avocado, Avocado pear, Azarole, Aztec berry, Azuki bean, Babaco, Baby jackfruit, Baby kiwi, Bachelor's buttons, Badea, Badian, Bael, Bajra, Balanzan tree, Balm, Balm, Balm of Gilead, Balsam, Balsam of Gilead, Balsam of Mecca, Bambara bean, Bambara groundnut, Bambarra groundnut, Bamboo, Bamboo, Bamboo, Bamboo shoots, Bamboo sprouts, Banana, Banana, Banana squash, Barbados cherry, Barbados gooseberry, Barbary fig, Barhal, Barley, Bartender, Basil, Bastaardappelbes, Bastard saffron, Bat nut, Bat nut, Batoko plum, Bay laurel, Bay leaf, Bay tree, Baygrape, Beach mulberry, Bean of India, Bearberry, Bearded hedgehog mushroom, Bearded tooth fungus, Bearded tooth mushroom, Bee's friend, Beefsteak plant, Beet, Beetroot, Belgian endive, Beli fruit, Bell bean, Bell fruit, Bell pepper, Bell pepper, Bell pepper, Belle of the night, Ben oil tree, Bengal cardamom, Bengal currant, Bengal gram, Benzoil tree, Bergamot, Bergamot orange, Betel, Betel leaf, Betel nut, Big daisy, Bigarade orange, Bignay, Bilberry, Bilberry, Bilimbi, Bilva, Bilwa, Binjai, Bird pepper, Biriba, Bishop's crown, Bishop's weed, Bishop's weed, Bitter bean, Bitter gourd, Bitter melon, Bitter orange, Bitter vetch, Bittergourd, Bitterleaf, Black cardamom, Black chokeberry, Black cumin (Bunium persicum), Black cumin (Nigella sativa), Black elder, Black gram, Black lentil, Black mulberry, Black mustard, Black pepper, Black radish, Black salsify, Black sapote, Black wattle, Black-and-white ebony, Black-eyed bean, Black-eyed pea, Black-hearts, Blackberry, Blackcurrant, Blackseed, Blaeberry, Blanched celery, Blood amaranth, Blowball, Blue agave, Blue Gum, Blue honeysuckle, Blue huckleberry, Blue lupin, Blue pea, Blue Whortleberry, Blue-berried honeysuckle, Bluebellvine, Blueberry, Bobwood, Bok choi, Bok choy, Boletus of the steppes, Borecole, Borojó, Bottle gourd, Bramble, Bramble, Bramble fruit, Bramble fruit, Brazil nut, Brazilian cherry, Brazilian grape tree, Brazilian pawpaw, Brazilian starfish, Bread wheat, Breadfruit, Breadfruit cousin, Breadnut, Brinjal, Broad bean, Broadleaf sage, Broccoli, Broom millet, Broom sorghum, Broom-corn, Brown cap mushroom, Brown cardamom, Brown hemp, Bruisewort, Brussels sprout, Buck's horn plantain, Buckwheat, Buddha fruit, Buddha fruit, Buddha's hand, Buffalo bean, Buffalo nut, Buffalo nut, Bugnay, Bulb onion, Bulbous chervil, Bull's heart, Bullock's heart, Bulrush millet, Buriti, Burmese grape, Burmese teak, Burr cucumber, Burr gherkin, Bush butter tree, Bush clover, Bush tea, Butter bean, Butter pear, Buttercup squash, Butterfly pea, Butterfruit, Butternut pumpkin, Butternut squash, Button mangosteen, Button mushroom, Cabbage, Cabbage-tree, Cacao, Cacao tree, Cactusvijg, Caigua, Cainito, Calabash, Calabaza pumpkin, Calamansi, Calamondin, Cambodian palm, Camelina, Camomile, Canada rice, Canadian maple, Canary grass, Canary seed, Candle millet, Candleberry tree, Candy Roaster, Cane apple, Canistel, Cannabis, Canola, Cantalope, Cantaloup, Cantaloupe, Cape gooseberry, Caper, Capsicum, Capsicum, Capsicum, Capsicum spp, Carambola, Caraway, Caraway seeds, Cardamom, Cardoon, Carnation, Carob, Carob tree, Carom seeds, Carrot, Casbanan, Cashew, Cashew apple, Cashew nut, Cassabanana, Cassava, Castor, Castor bean, Castor oil plant, Cat-tail millet, Catjang, Cattail millet, Cattley guava, Cattleya guava, Caucasian persimmon, Cauliflower, Cayenne, Cayenne cherry, Cebu hemp, Ceiba, Celeriac, Celery, Celery cabbage, Celery lettuce, Celery root, Celtuce, Cempedak, Centella, Ceylon cinnamon, Ceylon spinach, Chadon, Chamburo, Chameleon plant, Chamomile, Champignon mushroom, Chard, Charichuelo, Chase-devil, Chat, Chay root, Chayote, Cheese fruit, Chempedak, Chempedek, Cherapu, Cherimoya, Cherry, Cherry of the Rio Grande, Cherry plum, Cherry silverberry, Chervil, Chestnut, Chestnut mushroom, Chestnut mushroom, Chia, Chichinga, Chicken tree, Chickpea, Chicory, Chilacayote, Chile pepper, Chile pepper, Chilgoza pine, Chili, Chili, Chili pepper, Chili pepper, Chili pepper, Chili pepper, Chilli, Chilli pepper, Chilli pepper, China grass, China wood oil, Chinese apple, Chinese bayberry, Chinese cabbage, Chinese cabbage, Chinese cassia, Chinese cinnamon, Chinese date, Chinese gooseberry, Chinese grapefruit, Chinese hawthorn, Chinese jujube, Chinese lettuce, Chinese lizard tail, Chinese long bean, Chinese mustard, Chinese parsley, Chinese pear, Chinese pearl barley, Chinese plum, Chinese potato, Chinese spinach, Chinese spinach, Chinese star anise, Chinese strawberry tree, Chinese tallow tree, Chinese water chestnut, Chinese white pear, Chinese white radish, Chinese wolfberry, Chinese yam, Chinese-laurel, Chirimoyo, Chirimuya, Chives, Chocho, Chocolate pudding fruit, Chokeberry, Choy root, Christophene, Christophine, Chrysanth, Chrysanthemum, Chufa sedge, Cicely, Cilantro, Cinnamon, Citron, Citronella, Citronella grass, Citrus xmitis, Clementine, Clove, Clover, Cluster bean, Coca, Cochinchin gourd, Cocktail kiwi, Coco, Cocoa tree, Cocona, Coconut, Coconut palm, Cocoplum, Cocoyam, Cocoyam, Coffee, Coffee shrub of Arabia, Coixseed, Cola nut, Coleus potato, Colewort, Common barley, Common bean, Common bilberry, Common Buckwheat, Common carrot, Common daisy, Common dandelion, Common elder, Common fig, Common flax, Common grape vine, Common guava, Common Hazel, Common hop, Common hyacinth, Common ice plant, Common jack bean, Common Jasmine, Common juniper, Common lavender, Common madder, Common mango, Common medlar, Common millet, Common mushroom, Common myrrh, Common onion, Common pawpaw, Common persimmon, Common plum, Common purslane, Common rue, Common sage, Common salsify, Common sorrel, Common St John's wort, Common thyme, Common turmeric, Common vetch, Common walnut, Common wheat, Common wormwood, Conderella plant, Congo pea, Cordofan pea, Coriander, Coriander leaves, Corkwood, Corn, Corn mint, Corn salad, Costa Rica Pitahaya, Cotton, Cotton fruit, Cotton lavender, Country bean, Country gooseberry, Country potato, Cow horn pepper, Cowa, Cowberry, Cowhage, Cowitch, Cowpea, Craboo, Cranberry, Cranberry, Cremini mushroom, Creole cotton, Cress, Crimson clover, Crocus, Crotalaria, Crystalline iceplant, Cucumber, Cucumber tree, Cuke, Culantro, Culinary sage, Cultivated mushroom, Cultivated tobacco, Cumin, Cummin, Cumquat, Curd fruit, Curly leaf parsley, Currant, Currant tree, Cushaw pumpkin, Custard apple, Custard apple, Custard apple, Daffodil, Dahlia, Daikon, Daikon radish, Daisy, Dalmatian chrysanthemum, Dalmatian insect flower, Dalmatian pellitory, Dalmatian pyrethrum, Dandelion, Dark millet, Darwin pea, Dasheen, Date, Date palm, Date-plum, Datil pepper, Davao hemp, Deer nut, Dengen, Dessert kiwi, Devil pod, Devil pod, Devil's tongue, Dill, Dill weed, Dinkel wheat, Dishrag gourd, Dog rose, Dolichos bean, Donkey eye, Dragon eye, Dragon fruit, Dragon herb, Dragon's eye, Dragon's-wort, Dragonfruit, Dragonfruit, Dragonfruit, Drumstick, Drumstick tree, Durhum wheat, Durian, Durra, Durum wheat, Dutch clover, Dutch hyacinth, Dyer's madder, Dyer's mulberry, Earth almond, Earth apple, Earth chestnut, Earth pea, Earthnut, Earthnut pea, East Indian spinach, East-Indian screw tree, Eastern persimmon, Eddoe, Egg-fruit, Egg-plant, Eggplant, Eglantine rose, Egyptian cotton, Egyptian cucumber, Egyptian leek, Egyptian privet, Einkorn wheat, Elder, Elder bush, Elderberry, Elderflower, Elephant apple, Elephant bread, Elephant foot, Elephant foot aroid, Elephant foot yam, Elephant garlic, Elephant yam, Elephant yam, Elephant-apple, Emblic, Emblic myrobalan, Emmer, Emmer wheat, Endive, English daisy, English lavender, English walnut, Enoki, Enokitake, Enset, Ensiform bean, Epazote, Erba stella, Erva mate, Eschalot, Esparcet, Ethiopian Banana, Ethiopian eggplant, Ethiopian mustard, Ethiopian nightshade, European black elderberry, European blueberry, European elder, European elderberry, European gooseberry, European nettle tree, European pear, European pennyroyal, European plum, European raspberry, European wild apple, European yellow lupine, Faba bean, Falsa, False banana, False flax, False mangosteen, Farro, Fat-hen, Fatalii, Fava bean, Featherfew, Feijoa, Fennel, Fenugreek, Fetticus, Feverfew, Field bean, Field mint, Field pea, Field salad, Fig, Fig tree, Fig-leaf gourd, Filbert nut, Finger millet, Fingered citron, Fique, Fish mint, Fishwort, Fitweed, Flat leaf parsley, Flat-leaved vanilla, Flax, Florence fennel, Florida aspen, Fluted gourd, Fluted pumpkin, Fodder beet, Fodder radish, Fonio, Forage radish, Four-angled bean, Foxtail millet, Fragrant cananga, Framboise, Frankincense, Fraughan, Freesia, French bean, French endive, French horn mushroom, Gac, Gac fruit, Gage, Gamboge, Gandaria, Gandule bean, Garden asparagus, Garden beet, Garden chervil, Garden cress, Garden eggs, Garden hyacinth, Garden onion, Garden parsley, Garden pepper cress, Garden rocket, Garden sage, Garden sorrel, Garden strawberry, Garden valerian, Garlic, Gat, Gaub, Gaub tree, Gboma, Gean, Genip, Genipapo, Genipe, Geocarpa groundnut, Gerbera, German chamomile, German turnip, Gherkin, Giant granadilla, Giant ground cherry, Giant stock bean, Giant timber bamboo, Giant Tumbo, Ginger, Ginseng, Globe artichoke, Goa bean, Goat nut, Goatsbeard, Goatweed, Goji berry, Goji berry, Gold-of-pleasure, Golden apple, Golden apple, Golden berry, Golden gram, Golden needle mushroom, Golden oyster mushroom, Golden passion fruit, Golden spoon, Goldenleaf tree, Goober pea, Good King Henry, Gooseberry, Gooseberry tree, Goosefoot, Gotu kola, Goumi, Gourd, Governor's plum, Grains of Paradise, Gram pea, Grand wormwood, Grape, Grape-kiwi, Grapefruit, Grass pea, Gray box bush, Gray popcorn tree, Gray santolina, Great morinda, Great pignut, Greater cardamom, Grecian laurel, Green amaranth, Green asparagus, Green bean, Green cardamom, Green ginger, Green gram, Green mustard cabbage, Green onion, Green pedalai, Green pepper, Green pepper, Green pepper, Green pepper, Green shallots, Greengage, Grenadia, Grey oyster mushroom, Ground-bean, Groundnut, Grumichama, Guaiabila, Guar, Guar bean, Guava, Guavasteen, Guayabilla, Guinea corn, Guinea grains, Guinea pepper, Guinea spice, Guinea yam, Gum acacia, Gum arabic, Gum arabic tree, Gum myrrh, Gum senegal tree, Gumi, Gunga pea, Habanero chili, Hairy crabgrass, Hamburg root parsley, Hardy kiwi, Hardy kiwifruit, Haricot bean, Hausa groundnut, Hausa potato, Hazelnut, Head cabbage, Heading cabbage, Heartleaf, Hedged gourd, Hemp, Henequen, Henequin, Heniquen, Henna, Henna tree, Herb hyssop, Herb-of-Grace, High blueberry, Hill cardamom, Himalayan spinach, Hina, Hog millet, Hog plum, Holy basil, Honeybell, Honeyberry, Honeyberry, Honeyberry, Hop, Horned melon, Horse bean, Horse gram, Horse mango, Horse parsley, Horse-hoof, Horseradish, Horseradish tree, Hot chili pepper, Hot chili peppers, Hot chili peppers, Hubbard squash, Huckleberry, Huito, Hulled wheat, Hungry rice, Hyacinth, Hyacinth bean, Hyssop, Icaco, Ice apple, Iceberg lettuce, Iceplant, Icicle radish, llama, Imbe, Inca berry, Incense tree, Indian baby pumpkin, Indian barnyard millet, Indian bean, Indian cardamom, Indian fig, Indian gooseberry, Indian hemp, Indian jujube, Indian lettuce, Indian lilac, Indian Lotus, Indian mulberry, Indian mustard, Indian oyster, Indian pea, Indian pennywort, Indian plum, Indian rice, Indian round gourd, Indian rubber bush, Indian saag, Indian saffron, Indian screw tree, Indian spinach, Indian vetch, Indigo, Indonesian cinnamon, Industrial hemp, Iris, Irish daisy, Irish strawberry tree, Iroko, Ita, Italian brown, Italian clover, Italian mushroom, Italian oyster, Italian stone pine, Ité palm, Ivy gourd, Jabotica, Jaboticaba, Jabuticaba, Jack bean, Jackalberry, Jackfruit, Jagua, Jalapeno, Jamaica pepper, Jamaican apple, Jambolan, Jambolan plum, Jambu bol, Jambul, Jamun, Japanese arrowroot, Japanese barnyard millet, Japanese bayberry, Japanese clover, Japanese horseradish, Japanese medlar, Japanese millet, Japanese mountain yam, Japanese pear, Japanese persimmon, Japanese plum, Japanese radish, Japanese stone oak, Japanese wineberry, Jarrandale pumpkin, Jasmine, Java apple, Java cotton, Java kapok, Java plum, Jelly ear, Jelly melon, Jerusalem artichoke, Jessamine, Jesuit's tea, Jew's ear, Jicama, Job's tears, Jocote, Johey oak, Jojoba, Jowar, Jowari, Judas's ear, Jugo bean, Jujube, Jujube, Juniper berry, Jute, Jute, Kabocha, Kaffir lime, Kaki persimmon, Kakrol, Kale, Kamagong, Kanariezaad, Kangkong, Kapok, Karamda, Karanda, Karite, Karite nuts, Karonda, Kava, Kava-Kava, Kei apple, Kenaf, Kepel apple, Kepel fruit, Keppel, Keppel apple, Kersting's groundnut, Ketembilla, Key lime, Khat, Khorasan wheat, Kidney bean, Kieffer lime, Killarney strawberry tree, King brown mushroom, King oyster mushroom, King trumpet mushroom, Kitchen sage, Kitembilla, Kiwano, Kiwi, Kiwi berry, Kiwifruit, Klamath weed, Knob celery, Knotted marjoram, Kohlrabi, Kola nut, Kola tree, Konjac, Konjak, Konjaku, Konnyaku potato, Koracan, Korean mango, Korean pear, Korean pine, Korean yam, Korintje, Korlan, Kraabu, Kren, Kubal vine, Kudzu, Kumquat, Kurrat, Kutjera, Kuwini mango, Kwai Muk, Lacy Phacelia, Ladies fingers, Lady fingers, Lady's fingers, Laichi, Lakoocha, Lakota squash, Lamb's lettuce, Lamb's quarters, Langsat, Lao basil, Large crabgrass, Large cranberry, Large num-num, Lau Lau, Laurel, Laurel tree, Lavender, Laver, Lawn daisy, Leaf cactus, Leaf mustard, Leek, Lemon, Lemon balm, Lemon basil, Lemon beebrush, Lemon drop, Lemon grass, Lemon guava, Lemon verbena, Lentil, Lespedeza, Lettuce, Lewiston cornsalad, Liberian coffee, Lichu, Licorice, Lily mushroom, Lima bean, Limus, Linchee, Lingonberry, Linseed, Linseed dodder, Lion's mane mushroom, Lion's-tooth, Liquorice, Litchi, Lizard tail, Locoto, Locust bean, Long bean, Long coriander, Long white radish, Long-podded cowpea, Longan, Longevity spinach, Longkong, Loquat, Lotus, Lovage, Love apple, Lovegrass, Lowveld Mangosteen, Lucerne, Lucerne grass, Lulo, Lung oyster, Luo han guo, Lupin, Lupine, Lusho fruit, Lychee, Mabolo, Maca, Macadamia, Macaroni wheat, Mace, Machang, Madagascar potato, Madame Jeanette, Madang, Madder, Madras hemp, Madrono, Mafai, Maize, Makiang, Malabar ebony, Malabar gourd, Malabar nightshade, Malabar plum, Malabar spinach, Malabar squash, Malacca apple, Malacca tree, Malaguete pepper, Malay apple, Malay apple, Malay apple, Malay gooseberry, Malay rose apple, Malaysian Mango, Mallow-leaves, Malmut, Mamey, Mamey apple, Mamey sapote, Mammee, Mammee apple, Mamoncillo, Manchurian wild rice, Mandarin, Mandarin orange, Mandarine, Mangel, Mangelwurzel, Mango, Mangold wurzel, Mangosteen, Manila hemp, Manioc, Maprang, Marang, Marian plum, Marigold, Marihuana, Marijuana, Marjoram, Marmalade orange, Marron, Marrow, Mashua, Mashwa, Masoor, Matrimony vine, Matrimony vine, Matsutake, Matsutake mushroom, Mede berry, Mede berry, Medicinal aloe, Mediterranean hackberry, Mediterranean medlar, Medlar, Melde, Melegueta pepper, Melon, Melon pear, Meridian fennel, Mexican coriander, Mexican cotton, Mexican grain amaranth, Mexican lime, Mexican tea, Mexican turnip, Mexican yam, Midshipman's butter, Mignonette tree, Miner's lettuce, Mint, Minutina, Mirabelle plum, Mirabelle prune, Miracle berry, Miracle fruit, Miraculous berry, Mock tomato, Momona, Monk fruit, Monk's fruit, Monkey fruit, Monkey Jack, Monkey nut, Monkey-apple, Moonflower, Moong bean, Moriche palm, Moringa, Moso bamboo, Mosphilla, Mosquito plant, Moth bean, Mountain apple, Mountain apple, Mountain coffee, Mountain papaya, Mountain paw paw, Mountain soursop, Mulberry, Multiplier onion, Mum, Mung bean, Muntain currant, Musk cucumber, Muskmelon, Mustard greens, Myrobalan, Myrobalan plum, Myrtle blueberry, Nagaimo, Nagami kumquat, Nakati, Nance, Napa cabbage, Naranjilla, Narrow-leafed lupin, Narrow-leaved lavender, Narrowleaf lupine, Naseberry, Nashi pear, Natal plum, Native pear, Native potato, Natsugumi, Nectarine, Neem, Neep, Nepal cardamom, New cocoyam, New Zealand flax, New Zealand yam, Newspice, Niger seed, Night blooming cereus, No-eye pea, Noni, Noodle squash, Noog, Nopal, Northern highbush blueberry, Northern wild rice, Norway spruce, Noug, Nsafu, Nug, Nut-leaved screw tree, Nutmeg, Nyjer, Oat, Oats, Obedience plant, Oca, Oil grass, Oil palm, Oilseed radish, Oilseed rape, Oka, Okinawan spinach, Okra, Old cocoyam, Old fustic, Oldham's bamboo, Olive, Olive tree, Onion, Opium, Opium poppy, Orange, Orange pepper, Oregano, Oriental radish, Oriental wheat, Otaheite gooseberry, Oval kumquat, Ox heart, Oyster mushroom, Oysterplant, Padang cassia, Paddy straw mushroom, Padwal, Pak choi, Pak choy, Pale moon ebony, Palmyra palm, Pandan, Papaw, Papaya, Papayuelo, Para rubber, Para guava, Para rubber tree, Paracress, Paradise nut, Paradise plum, Parasol pine, Paris mushroom, Parsley, Parsnip, Parsnip chervil, Parwal, Passion fruit, Passionfruit, Paw paw, Paw-paw, Pawpaw, Pawpaw, Pea, Peach, Peach palm, Peach-palm, Peanut, Pear, Pear squash, Pearl lupin, Pearl millet, Pecan nut, Pennyroyal, Pepino, Pepino melon, Peppadew, Peppermint, Perennial goosefoot, Perforate St John's wort, Perfume tree, Perilla, Persian cumin, Persian walnut, Persimmon, Peruvian cherry, Peruvian ground apple, Peruvian groundcherry, Peruvian guava, Pewa, Phalsa, Phoenix mushroom, Pie cherry, Pig nut, Pigeon pea, Pignut, Pigweed, Pigweed, Pima cotton, Pineapple, Pineapple guava, Pink currant, Pipian, Pin piri, Pistachio, Pistachio nut, Pitahaya, Pitanga, Pitaya, Pitomba, Pitomba, Plantain, Plantain, Plum, Plum mango, Plum rose, Poet's Jasmine, Pointed gourd, Polish Millet, Pomegranate, Pomelo, Pommelo, Pompelmous, Pond apple, Poor-man's Asparagus, Poplar mushroom, Poppy seed, Portobello mushroom, Possumwood, Pot marigold, Potato, Potato onion, Prairie banana, Prickly custard apple, Prickly pear, Prince's feather, Proso millet, Prune, Pudding grass, Puff-ball, Pulasan, Pummelo, Pumpkin, Pumpkin, Pumpkin, Pumpkin, Purple amaranth, Purple chokeberry, Purple Mangosteen, Purple mombin, Purple passion fruit, Purple pitaya, Purple salsify, Pygmy nut, Pyrethrum, Pyrethrum daisy, Queen of the night, Queensland nut, Queensland-cherry, Quince, Quinine, Quinine bark, Quinine nut, Quinoa, Racacha, Radish, Rag gourd, Ragi, Rambutan, Ramie, Ramontchi, Ramtil, Ramtilla, Rape, Rapeseed, Rapunzel, Raspberry, Red acacia, Red amaranth, Red bayberry, Red beet, Red cabbage, Red chokeberry, Red clover, Red currant, Red date, Red endive, Red gram, Red grape, Red hog plum, Red medlar, Red medlar, Red mombin, Red mulberry, Red pepper, Red pepper, Red pepper, Red pepper, Red pitahaya, Red pitaya, Red Raspberry, Red tea, Red-fruited strawberry guava, Redbush tea, Redcurrant, Reine Claude, Rhubarb, Rib gourd, Ribbed celery, Ribbed gourd, Ribbed loofah, Rice, Rice bean, Ricebean, Ridged gourd, Ridged luffa, River spinach, Robusta coffee, Rocket, Rocketsalad, Rocoto, Roman brown mushroom, Rooibos, Root chicory, Root parsley, Rose, Rose apple, Rose apple, Rose apple, Rose hip, Rose hip, Rosebush, Rosella, Rosella fruit, Roselle, Rosemary, Rosin rose, Royal apple, Rubber bush, Rubber fig, Rubber plant, Rubber tree, Rue, Runner bean, Rutabaga, Rye, Sacred Lotus, Sacred tree, Safflower, Saffron, Saffron crocus, Safou, Sage, Sago palm, Saigon cinnamon, Sainfoin, Saint Joseph's wort, Saipan mango, Salad onion, Salak, Salamander-tree, Salmonberry, Salsify, Sand pear, Sandorica, Santo Domingo apricot, Santol, Sapodilla, Sapucaia, Satsuma, Satyr's beard, Savanna serret, Savanna serrette, Savory, Savory, Savoy cabbage, Saw-leaf herb, Sawa millet, Sawtooth coriander, Sawtooth herb, Scallion, Scarlet runner bean, Scotch bonnet, Scots pine, Sea Island cotton, Sea kale, Sea lettuce, Seagrape, Seedless mandarin, Serpent gourd, Sesame, Sevilla orange, Seville orange, Shaddock, Shadon, Shadow benny, Shallot, Sharinga tree, Sharon Fruit, Shea butter, Shea nut, Shea tree, Sheanuts, Shiitake, Shiny-leaf Buckthorn, Shittah tree, Siam pumpkin, Siberian pine, Sichuan pepper, Sikana, Silk-cotton, Silver date palm, Silver ear fungus, Simmon, Simsim, Sineguela, Siriguela, Sisal, Sisal hemp, Slender amaranth, Slipper gourd, Smooth loofah, Smooth luffa, Smyrnium, Snake bean, Snake cucumber, Snake fruit, Snake gourd, Snake palm, Snakeskin fruit, Snow fungus, Snow pea, Soncoya, Sorghum, Sorghum, Sorrel, Sour apple, Sour cherry, Sour lime, Sour mangosteen, Sour orange, Soursop, South African red tea, South American apricot, South American lupin, Southern blue gum, Soya bean, Soybean, Spaghetti marrow, Spaghetti squash, Spanish lime, Spanish plum, Spanish salsify, Spanish tamarind, Sparrow grass, Spear mint, Spearmint, Spelt, Spelt wheat, Spiked millet, Spilanthes, Spinach, Spinach beet, Spiny bitter gourd, Spiny gourd, Spiritweed, Sponge gourd, Spring beauty, Spring onion, Spring onion, Squash, Squash, Squash, Squash, Squaw mint, Sri Lanka cinnamon, St John's wort, St. John's bread, Star anise, Star aniseed, Star apple, Star gooseberry, Starfruit, Stem lettuce, Stevia, Stink bean, Stink lily, Stone apple, Stone pine, Straw mushroom, Strawberry, Strawberry guava, Strawberry pear, Strawberry tree, Succade, Sudan grass, Sugar apple, Sugar beet, Sugar date palm, Sugar maple, Sugar palm, Sugarcane, Sugarleaf, Summer savory, Sunchoke, Sundrop, Sunflower, Sunhemp, Sunn hemp, Sunroot, Sudan, Surinam cherry, Surinam gooseberry, Surinam spinach, Swamp apple, Swamp blueberry, Swamp cabbage, Swamp huckleberry, Swede, Swedish turnip, Sweet basil, Sweet bay, Sweet berry, Sweet briar, Sweet cherry, Sweet chestnut, Sweet cicely, Sweet granadilla, Sweet leaf, Sweet lime, Sweet marjoram, Sweet orange, Sweet pepino, Sweet pepper, Sweet pepper, Sweet pepper, Sweet potato, Sweet yam, Sweetberry honeysuckle, Sweetleaf, Sweetsop, Swiss brown mushroom, Swiss chard, Szechuan pepper, Szechwan pepper, Tabasco pepper, Table beet, Table mushroom, Taf, Tahitian gooseberry, Taiwan pear, Tall huckleberry, Tamarillo, Tamarind, Tamarind of the Indies, Tangelo, Tangerine, Tannia, Tapioca, Tarap, Taro, Tarragon, Tart cherry, Tarwi, Tasmanian blue gum, Tea, Tea plant, Tea shrub, Tea tree, Teak, Tear grass, Teasle gourd, Tef, Teff, Tepary bean, Tequila agave, Terap, Texas wild rice, Thai basil, Thai holy basil, Thai lemon basil, Thai long pepper, Thai marrow, Thai pepper, Thyme, Thymol seeds, Tigernut sedge, Timadang, Timothy, Timothy-grass, Tinda, Tindora, Tipton's weed, Tobacco, Tobacco plant, Toddy palm, Tomatillo, Tomato, Toor dal, Toothache plant, Topinambour, Tossa jute, Tree chili, Tree cotton, Tree melon, Tree melon, Tree oyster mushroom, Tree sorrel, Tree tomato, Trefoil, Trefoil, Triticale, Tropical apricot, Tropical green pea, True aloe, True cardamom, True cinnamon, True date palm, True indigo, True laurel, True lavender, True ramie, True sage, True sago palm, True yellow mombin, Trumpet royale, Tuberous nasturtium, Tuberous pea, Tuberous-rooted chervil, Tucum, Tucuma palm, Tulip, Tulsi, Tung nut, Tung oil, Tung tree, Turkish gram, Turmeric, Turnip, Turnip, Turnip-rooted celery, Turnip-rooted chervil, Twisted cluster bean, Ugli, Ugli fruit, Umbrella pine, Umkokola, Upland cotton, Urad bean, Urad dal, Valerian, Vanilla, Vanilla orchid, Vavangue tree, Vegetable brain, Vegetable gourd, Vegetable pear, Vegetable spaghetti, Vegetable sponge, Velvet apple, Velvet bean, Velvet persimmon, Velvet pioppino, Verdolaga, Vetch, Vetiver, Vetiver grass, Vietnam coriander, Vietnamese cassia, Vietnamese cinnamon, Vietnamese fish plant, Vietnamese luffa, Vine pear, Vine spinach, Viper's grass, Viper's herb, Vitellaria, Voodoo lily, Walnut, Wampee, Warm Season Annual Bunch Grass, Wasabi, Water apple, Water apple, Water apple, Water apple, Water caltrop, Water caltrop, Water cherry, Water chestnut, Water chestnut, Water chestnut, Water convolvulus, Water morning glory, Water oats, Water spinach, Watercress, Watermelon, Watery rose apple, Wax apple, Wax apple, Wax gourd, Wax jambu, Welsh onion, West African okra, West India gooseberry, West Indian Ben, West Indian cherry, West Indian gherkin, West Indian lime, Wheat, Whinberry, White asparagus, White cabbage, White carrot, White carrot, White clover, White currant, White fonio, White goosefoot, White gourd, White grape, White jelly mushroom, White jute, White lupin, White millet, White mulberry, White mushroom, White mustard, White pepper, White radish, White ramie, White sapote, White star apple, White turnip, White yam, Whitecurrant, Whitespot giant arum, Whortleberry, Whortleberry, Wild artichoke, Wild baccatum, Wild banana, Wild betel, Wild cherry, Wild cherry, Wild coriander, Wild crapemyrtle, Wild flax, Wild hazel, Wild mangosteen, Wild mint, Wild rice, Wild sugar apple, Wild sweetsop, Wimberry, Winberry, Windberry, Wine raspberry, Wineberry, Winged bean, Winged cardamom, Winged pea, Winter cabbage, Winter endive, Winter melon, Winter purslane, Winter radish, Winter savory, Winter thorn, Witloof, Wolfberry, Wolfberry, Wonder bean, Wood apple, Wood apple, Wood berry, Wood ear, Wood-apple, Wormseed, Wormwood, Woundwort, Xigua, Ya pear, Yacón, Yam, Yam bean, Yamamomo, Yangmei, Yard-long bean, Yard-long cucumber, Yautia, Yellow hog plum, Yellow lantern chili, Yellow lupin, Yellow mangosteen, Yellow mombin, Yellow nutsedge, Yellow pitaya, Yellow sapote, Yellow star apple, Yellow turnip, Yellow-fruited strawberry guava, Yerba mate, Ylang-ylang tree, Yuca, Yumberry, Zucchini|

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1: Interpenetrating Network Formed by Polymerizing a Thermoresponsive Polymer in the Presence of a Hygroscopic Polymer

Pyrrole monomer, ammonium persulfate (“APS”) and LiCl (molar ratio 1:1:1) was gradually added into an aqueous HCl solution (3.7% wt). The polymerization reaction was stopped by vacuum filtering and washing. The obtained black product was dispersed in DI water by sonication. The resulting PPyCl polymer (50 μg), N-isopropylacrylamide (“NIPAM”) monomers (567 mg), N, N-tetramethylenediamine (10 μl) and deionized water (10 mL) were mixed together and purged with nitrogen for ten minutes, followed by centrifugation for five min with a speed of 7000 rpm. Then N′,N′-methylenebisacrylamide (0.3 mg) and APS (0.56 mg) were added into the solution. The polymerization was carried out for 12 h. The obtained hydrogel was immersed into DI water overnight to remove unreacted monomers.

### Example 2: Interpenetrating Network Formed by Polymerizing a Hygroscopic Polymer in the Presence of a Thermoresponsive Polymer

N-isopropylacrylamide monomers (56.7 mg), N, N-tetramethylenediamine (1 μL) and deionized (DI) water (1 mL) were mixed and purged with nitrogen for 10 min. Then the N, N-methylenebisacrylamide solution (100 μL, 30 mg/mL), ammonium persulfate solution (APS, 50 μL 22. 8 mg/mL) and PPy-Cl solution (0.5 mL, 10 mg/mL) were added under sonication. The solution was purged with nitrogen for 10 min before adding the APS initiator. The polymerization was carried out for 12 h. The obtained gel was immersed into cold water (5° C.) and hot DI water (ca. 80° C.) alternately for 3 h to remove unreacted monomers. The purification step was repeated 3 times.

### Example 3: Preparation of SMAG Soil

SMAG (1 g) was mixed with soil (or sand, 5 g). The obtained mixture was grinded with dropwise added water (1 g). Then the wet SMAG-soil (sand) is dried at 90° C. in a vacuume oven for 12 h. SMAG (1 g) was mixed with soil (or sand, 5 g). The obtained mixture was grinded with dropwise added water (1 g). Then the wet SMAG-soil (sand) is dried at 90° C. in a vacuume oven for 12 h.

### Example 4: Assessment of Water Capture and Release

The as-prepared soil samples are completely dried in vacuum oven at 100° C. prior the measurement and then set in relative humidity (RH) control system. The RH in the container was stabilized to the desired value by a super-saturated solution of specific salt. The weight of these samples was carefully tracked by microbalance during the hydration process until the water content reach the equilibrium (no weight change in 30 min). The water uptake profile can be obtained by the weight change of samples over time.

The hydrated soil samples are set in RH control system. The RH in the container was stabilized to the designed value by a super-saturated solution of specific salt. The weight of these samples was carefully tracked by microbalance during the dehydration process until the water content reach the equilibrium (no weight change in 30 min). The water releasing profile can be obtained by the weight change of samples over time.

### Example 5: SMAG Soils Improve Agricultural Performance

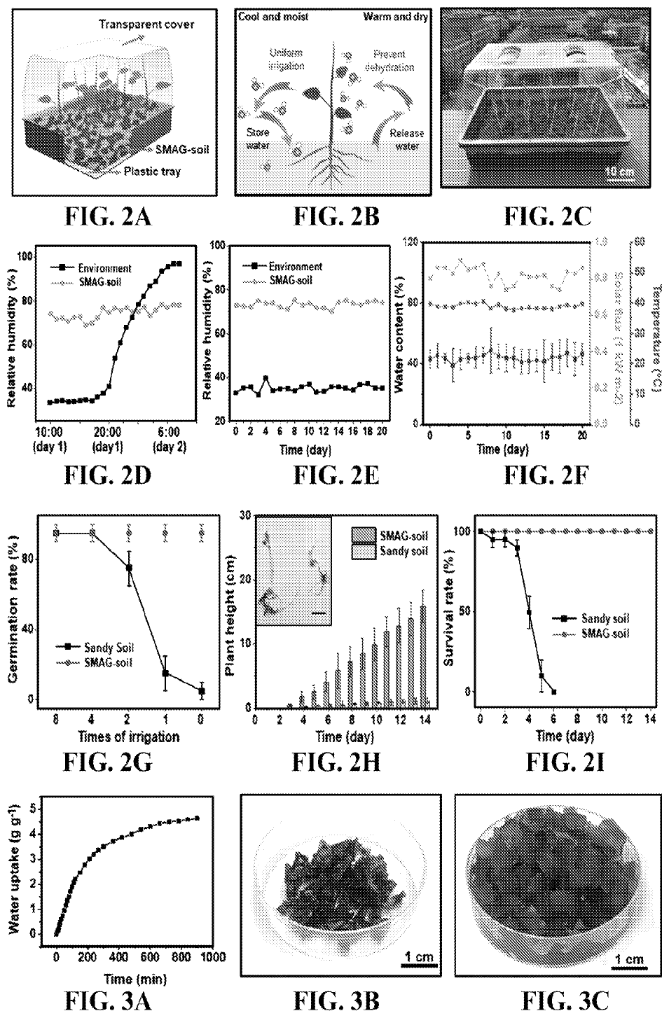

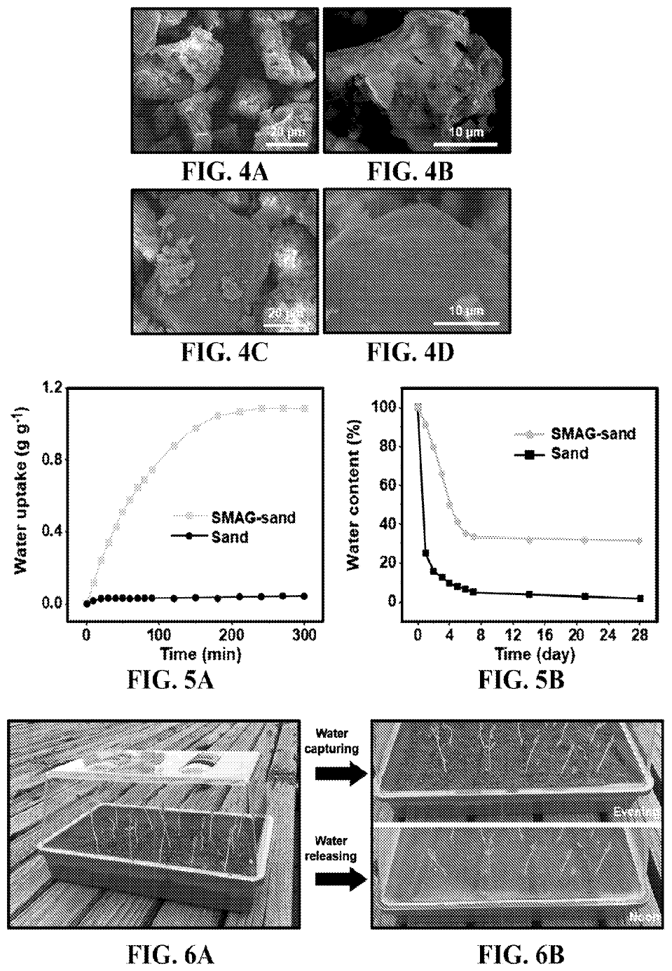

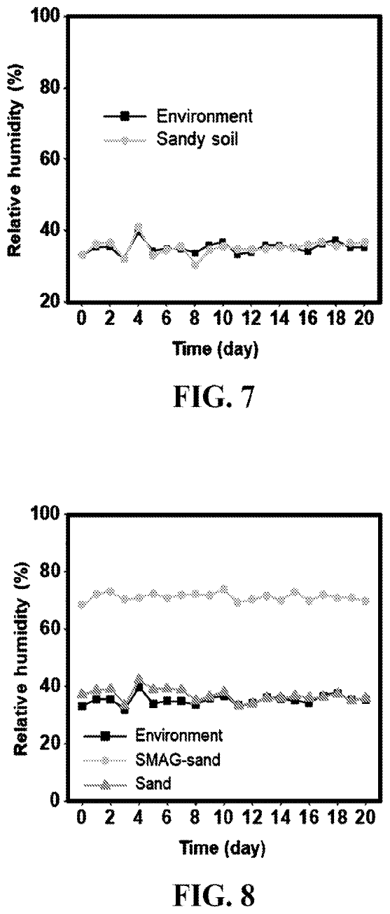

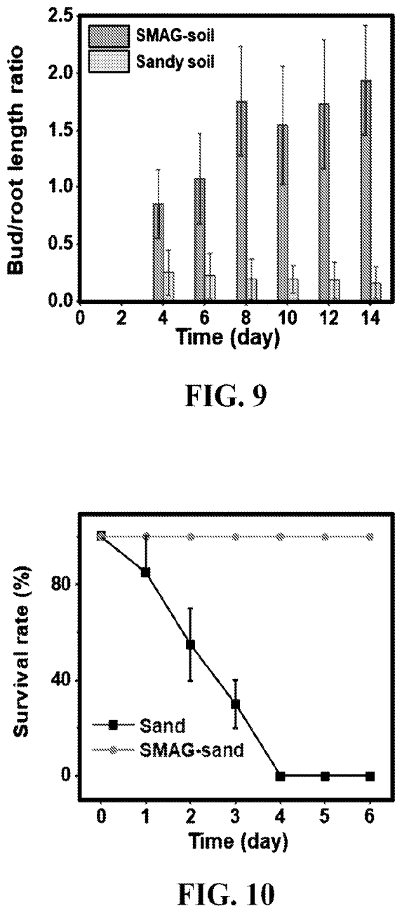

Radish seeds were used to test the SMAG soil performance. Since the sprouting period of the radish seed is 4 days, we irrigated the SMAG-soil and the sandy soil every half-day (i.e., 8 times in total), every day (i.e., 4 times in total), every two days (i.e., twice in total), every four days (i.e., once in total) as control groups of the sample with atmospheric irrigation only (FIG. 2g). The SMAG-soil shows a stable germination rate over 95% with or without liquid water irrigation. In contrast, the germination rate of the sandy soil group is reduced sharply when the water irrigation time is lower than 4 times in total. To compare the SMAG-soil and sandy soil on bud growth, we conducted liquid water irrigation in day 0 to guarantee the sprout of seed in sandy soil while SMAG-solid did not need any initial liquid water irrigation. With adequate water supply and stable RH condition enabled by the SMAG-soil, the radish seeds germinate in only 2 days and the bud grows fast and becomes ˜15 cm long in day 14 without liquid water irrigation. In the sandy soil, the germination time is longer and the plant height can only reach to 1 cm (FIG. 2h). The low bud/root ratio of radish planted in the sandy soil indicates a lack of water (FIG. 9). Moreover, the plant survival rates in the SMAG-soil and the sandy soil without liquid water irrigation further confirm the practicability of our SMAG-soil based sustainable agricultural system and the importance of water retention in the soil for plant growth (FIG. 10). All the plants in the SMAG-soil based system survived after 14 days without liquid water irrigation, while the control group based on sandy soil presents 0% survival rate after 6 days (FIG. 2i).

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1. A modified soil composition comprising:
a) water harvesting material comprising an interpenetrating network comprising:
i) a hygroscopic polymer; and
ii) a thermoresponsive water storage polymer; and
b) a soil.

2-3. (canceled)

4. The modified soil composition of claim 1, wherein the hygroscopic polymer comprises a polypyrrole, polyaniline, polycarbazole, polyindole, polyazepine or a copolymer thereof.

5-6. (canceled)

7. The modified soil composition of claim 3, wherein the hygroscopic polymer is doped at doping level of at least 0.010 holes per monomer.

8. The modified soil composition of claim 1, wherein the hygroscopic polymer comprises poly(pyrrole), poly(aniline), or a mixture thereof.

9. The modified soil composition of claim 1, wherein the hygroscopic polymer has a Mw less than about 500,000.

10. The modified soil composition of claim 1, wherein the thermoresponsive water storage polymer is characterized by a Lower Critical Solution Temperature between about 30-65° C., or

11-14. (canceled)

15. The modified soil composition of claim 1, wherein the thermoresponsive water storage polymer comprises a poly(N-alkylacrylamide), a poly(N,N-dialkylacrylamide), or a mixture thereof.

16-17. (canceled)

18. The modified soil composition of claim 1, wherein the thermoresponsive water storage polymer is derived from one or more monomers comprising N-isopropylacrylamide, N,N-dimethylacrylamide, or N,N-diethylacrylamide.

19. (canceled)

20. The modified soil composition of claim 18, wherein the thermoresponsive water storage is further derived from at least one crosslinking monomer.

21-22. (canceled)

23. The modified soil composition of claim 20, wherein the crosslinking monomer comprises N,N-methylenebisacrylamide, N,N-ethylenebisacrylamide, N,N-propylenebisacrylamide, N-allylacrylamide or N,N-diallylacrylamide, or a mixture thereof.

24. The modified soil composition of claim 1, wherein the ratio of hygroscopic polymer to thermoresponsive water storage polymer is from about 1:0.05-1:1.

25. (canceled)

26. The modified soil composition of claim 1, wherein the soil has a particle size from 0.5-2.0 mm prior to combination with the water harvesting polymer network.

27. The modified soil composition of claim 1, further comprising mulch, topsoil, hydroponics, gravel, compost, wood fibers, peat, forest bark, straw, loam, clay aggregate, or particulate plastic.

28. The modified soil composition of claim 1, wherein the water harvesting polymer network is present in an amount from 1-50% by weight, relative to the total weight of the modified soil composition.

29. The modified soil composition of claim 1, having a soil assembly structure with an average particle size from 1 μm to 1 cm.

30. (canceled)

31. A method of preparing a modified soil composition comprising combining a water harvesting polymer network with a soil, wherein the water harvesting polymer network comprises
i) a hygroscopic polymer; and
ii) a thermoresponsive water storage polymer.

32-40. (canceled)

41. A method of improving an agricultural field, comprising adding the modified soil composition of claim 1 to the agricultural field.

42. The method of claim 41, wherein the modified soil composition is added to the field at a rate of 0.1-1,000 lb/ft², 1-100 lb/ft², 5-100 lb/ft², 5-50 lb/ft², 5-25 lb/ft², 10-100 lb/ft², 10-50 lb/ft², 10-25 lb/ft², 25-100 lb/ft², 50-100 lb/ft², or 100-500 lb/ft².

43. The method of germinating a seed, comprising contacting the seed with the modified soil composition according to claim 1.

44. The method according to claim 43, wherein the seed is a fruit seed, vegetable seed, nut seed, ornamental plant seed, a forage seed, a field crop seed, or a tree seed.
